(19) United States
(12) Patent Application Publication
(10) Pub. No.: US 2008/0296340 A1
(43) Pub. Date: Dec. 4, 2008

(54) Dual-use nail magazine for U-shaped nail and T-shape nail

(75) Inventor: Ying-Tang Wang, Changhua County (TW)

Correspondence Address: BACON & THOMAS, PLLC, 625 SLATERS LANE, FOURTH FLOOR, ALEXANDRIA, VA, 22314-1176, US

(73) Assignee: MOBILETRON ELECTRONICS CO., LTD., TAICHUNG HSIEN (TW)

(21) Appl. No.: 11/892,695

(22) Filed: Aug. 27, 2007

(30) Foreign Application Priority Data
May 29, 2007 (CN) 200720148060.3

(51) Int. Cl. B27F 7/00

(52) U.S. Cl. 227/109

(57) ABSTRACT

A dual-use nail magazine for alternatively accommodating a T-shaped nail strip or an inverted U-shaped nail strip includes a track bar defining a first channel for receiving the T-shaped nail strip when it is used alone, a second channel, and a third channel cooperated with the first channel for receiving the inverted U-shaped nail strip. A nail pushing mechanism has a rod member suspended in the second channel, a nail push plate movably sleeved onto the rod member and having a first nail-pushing portion inserted into the first channel, and a second nail-pushing portion inserted into the third channel, and a compression spring sleeved onto the rod member for supporting and moving the nail pusher along the first channel and the third channel so as to push the T-shaped nail strip in the first channel or the inverted U-shaped nail strip in the first and third channels.

### BACKGROUND OF THE INVENTION

1. Field of the Invention

The present invention relates generally to a nail magazine for a nailing stapler and more particularly, to a dual-use nail magazine for a nailing stapler, which is capable of accommodating U-shaped nails or T-shaped nails alternatively.

2. Description of the Related Art

A conventional nail magazine, as shown in FIG. 1, comprises a magazine body 1, a nail output head 2 connected to one end of the magazine body 1, a protective cover (not shown) covering the magazine body 1, and a nail pushing mechanism. The magazine body 1 has a nail channel 3 on its one side corresponding to the protective cover for receiving a nail strip 4. The nail pushing mechanism is comprised of a nail push plate 5 and a spiral spring (not shown). The nail push plate 5 is stopped against the rear end of the loaded nail strip 4, and pulled by the spiral spring to move the nail strip 4 toward the nail outlet.

The aforesaid nail magazine uses a spiral spring to pull the nail push plate 5. The pulling position of the nail push plate 5 is not easy to control. During the pulling action, the nail strip 4 may be biased and jammed in the nail outlet. Further uneven pulling force from the spiral spring will tilt the nail push plate 5, causing friction between the nail push plate 5 and the magazine body 1 and resulting in nail feeding instability.

### SUMMARY OF THE INVENTION

The present invention has been accomplished under the circumstances in view. It is one objective of the present invention to provide a dual-use nail magazine for alternatively accommodating U-shaped nails and T-shaped nails, which pushes the loaded nail strip to the nail outlet smoothly, preventing a nail jam.

It is another objective of the present invention to provide a dual-use nail magazine for alternatively accommodating U-shaped nails and T-shaped nails, which enables the user to load the nail strip conveniently.

To achieve these objectives of the present invention, the dual-use nail magazine for alternatively accommodating a T-shaped nail strip or an inverted U-shaped nail strip includes a track bar and a nail pushing mechanism. The track bar has a first channel for receiving the T-shaped nail strip when it is used alone, a second channel, and a third channel for receiving the inverted U-shaped nail strip when it is cooperated with the first channel. The nail pushing mechanism has a rod member suspended in the second channel, a nail push plate movably sleeved onto the rod member and having a first nail-pushing portion inserted into the first channel, and a second nail-pushing portion inserted into the third channel, and a compression spring sleeved onto the rod member for supporting and moving the nail pusher along the first channel and the third channel so as to push the T-shaped nail strip in the first channel or the inverted U-shaped nail strip in the first and third channels.

In a preferred embodiment of the present invention, the dual-use nail magazine further comprises a limiter fastened to the track bar and provided with a retaining hole, and a sliding bar slidably coupled with the track bar and provided with a protruding portion stoppable at the limiter when the sliding bar is moved relative to the track bar by an external force to an open status. When the sliding bar is moved relative to the track bar a close status, a retaining member provided by a locating block affixed to an end of the sliding bar is engaged into the retaining hole of the limiter.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic drawing of a nail magazine according to the prior art;

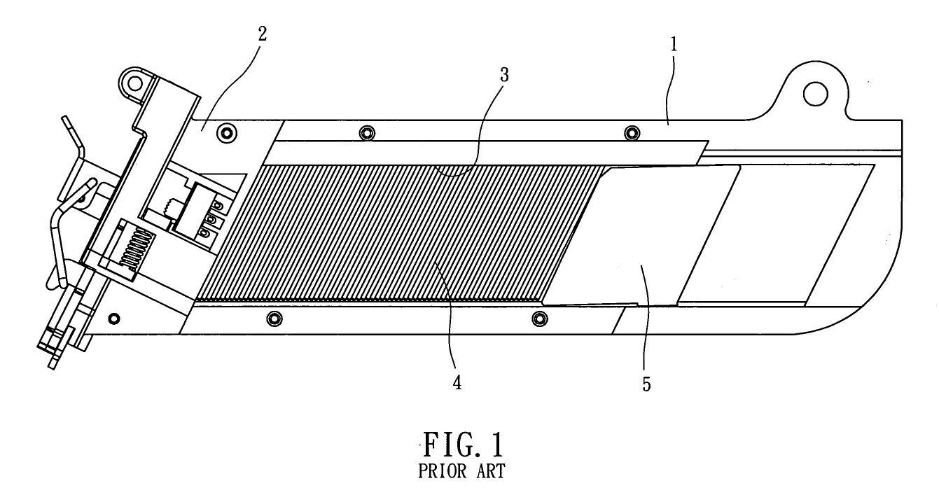

FIG. 2 is an exploded view of a dual-use nail magazine in accordance with a preferred embodiment of the present invention;

FIG. 3 is a sectional view of a part of the dual-use nail magazine in accordance with the preferred embodiment of the present invention;

FIG. 4 is a schematic drawing of the dual-use nail magazine in accordance with the preferred embodiment of the present invention, showing the sliding bar of the dual-use nail magazine is in the close position;

FIG. 5 is similar to FIG. 4 but showing the sliding bar is in the open position;

FIG. 6 is a schematic drawing of the dual-use nail magazine in accordance with the preferred embodiment of the present invent, showing a T-shaped nail strip is loaded in the track bar;

FIG. 7 is an end view corresponding to FIG. 6, showing the positioning status of the T-shaped nail strip in the nail output head;

FIG. 8 is a schematic drawing of the dual-use nail magazine in accordance with the preferred embodiment of the present invent, showing an inverted U-shaped nail strip loaded in the track bar; and

FIG. 9 is an end view corresponding to FIG. 8, showing the positioning status of the inverted U-shaped nail strip in the nail output head.

### DETAILED DESCRIPTION OF THE INVENTION

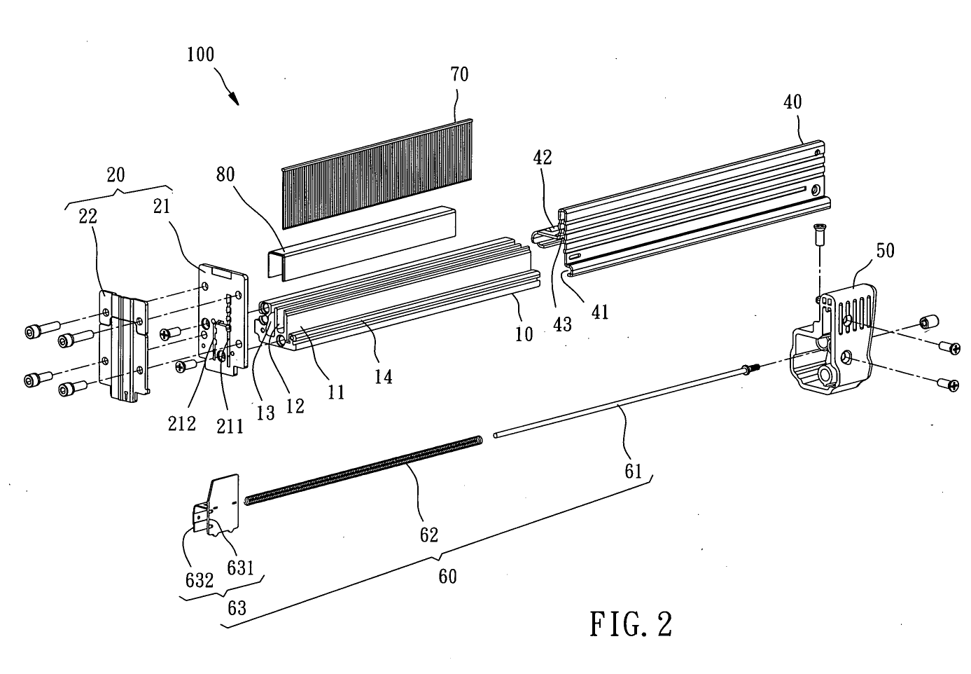

As shown in FIGS. 2-9, a dual-use nail magazine 100 for use with a nailing stapler for alternatively accommodating a strip of inverted U-shaped nails or a strip of T-shaped nails in accordance with a preferred embodiment of the present invention comprises a track bar 10, a nail output head 20, a limiter 30, a sliding bar 40, a locating block 50, and a nail pushing mechanism 60.

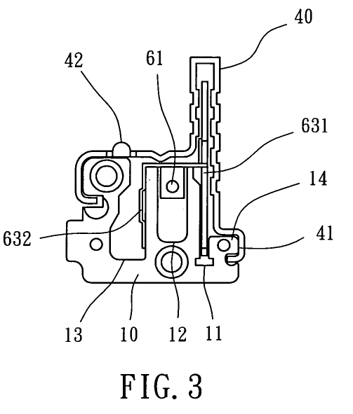

As shown in FIGS. 2 and 3, the track bar 10 is a narrow, elongated rectangular bar having a first channel 11, a second channel 12, and a third channel 13. These three channels 11-13 are recessed on one side, namely, the top side of the track bar 10 and longitudinally extending through the two distal ends of the track bar 10 in a parallel manner. The track bar 10 further has two longitudinal guide rails 14 respectively disposed at each of its two opposite lateral sides.

The nail output head 20 is comprised of a nail guiding plate 21 and a guard 22. The nail guiding plate 21 is fastened to one end (front end) of the track bar 10, defining a T-nail outlet 211 in communication with the first channel 11 and a U-nail outlet 212 in communication with the third channel 13 and the first channel 11. The guard 22 is fastened to the nail guiding plate 21, defining with the nail guiding plate 21 a nail output port (not shown).

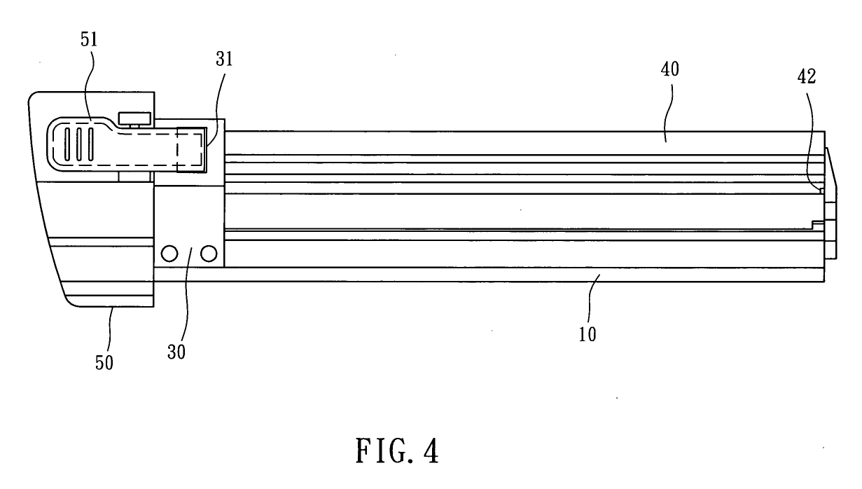

The limiter 30 is fastened to the track bar 10, defining a retaining hole 31 (see FIG. 4).

The sliding bar 40 is a single piece member fitting over the track bar 10, having two sliding grooves 41 longitudinally arranged in parallel at two opposite lateral sides and respectively coupled to the longitudinal guide rails 14 of the track bar 10 to guide reciprocation of the sliding bar 40 along the track bar 10 between an open position and a close position. The inside wall of the sliding bar 40 is configured to define with the track bar 10 a clearance of a predetermined configuration. The sliding bar 40 further has a plurality of nail guiding grooves 43 longitudinally disposed on the inside at different elevations for guiding T-shaped nails of different length, and a protruding portion 42 on the outside wall. When the sliding bar 40 is in the open position, the protruding portion 42 is stopped against the limiter 30 to prohibit the sliding bar 40 from falling out of the track bar 10.

The locating block 50 is affixed to the other end (rear end) of the track bar 10, having an elastic retaining member 51. When the sliding bar 40 is in the close position, the elastic retaining member 51 of the locating block 50 is forced into the retaining hole 31 of the limiter 30, thereby locking the sliding bar 40 to the track bar 10.

The nail pushing mechanism 60 is comprised of a rod member 61, a compression spring 62, and a nail push plate 63. The rod member 61 is suspending in the second channel 12 of the track bar 10, and affixed with its one end to the locating block 50. The compression spring 62 is sleeved onto the rod member 61 and stopped against the locating block 50. The nail push plate 63 has a substantially h-shaped cross section defining a first nail-pushing portion 631 and a second nail-pushing portion 632. The nail push plate 63 is sleeved onto the rod member 61 and stopped at one end of the compression spring 62 against the locating block 50, i.e., the compression spring 62 is stopped between the locating block 50 and the nail push plate 63. The front end of the rod member 60 remote from the locating block 50 may be mounted with a stop block (not shown) or expanded to prohibit the nail push plate 63 from falling out of the rod member 61. Further, the first nail-pushing portion 631 of the nail push plate 63 is inserted into the first channel 11 of the track bar 10, and the second nail-pushing portion 632 of the nail push plate 63 is inserted into the third channel 13 of the track bar 10.

After introduction of the component parts of the dual-use nail magazine and their relationship, the operational features of the dual-use nail magazine are outlined hereinafter.

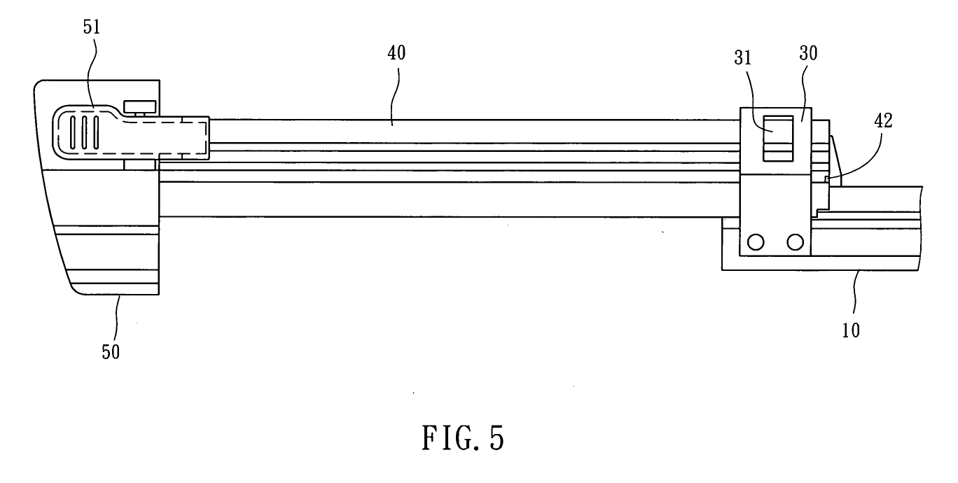

At first, when loading a nail strip, press the elastic retaining member 51 of the locating block 50 to disengage the elastic retaining member 51 from the retaining hole 31 of the limiter 30, and then move the sliding bar 40 from the close position (see FIG. 4) to the open position (see FIG. 5) to expose the channels 11-13 of the track bar 10. At this time, the user can load a T-shaped nail strip in the first channel 11 or insert the two opposite legs of the inverted U-shaped nails of an inverted U-shaped nail strip into the first channel 11 and the third channel 13 (inverted U-shaped nail strip and T-shaped nail strip commonly use the first channel, therefore only one type of nail strip can be loaded). After loading of an inverted U-shaped or T-shaped nail strip, move the sliding bar 40 to the close position to force the elastic retaining member 51 of the locating block 50 into engagement with the retaining hole 31 of the limiter 30 again.

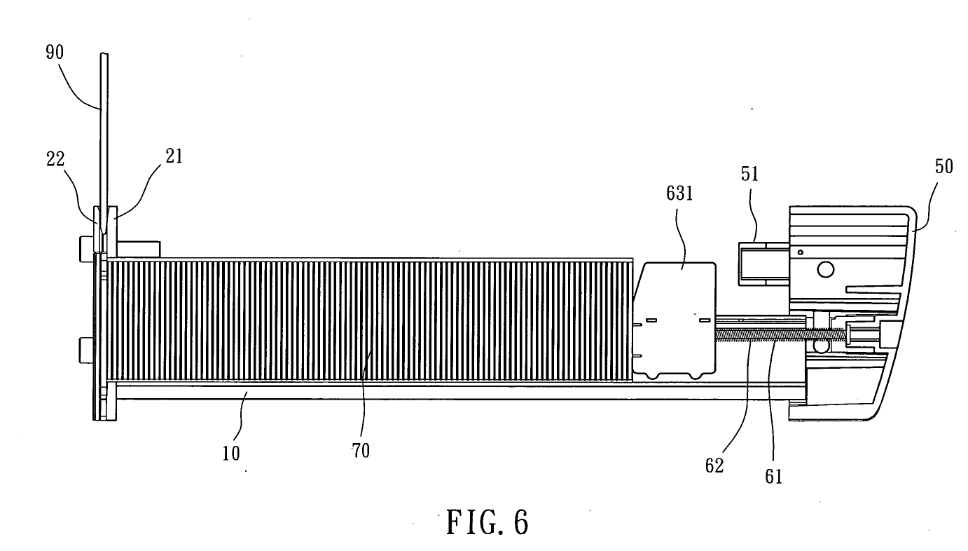

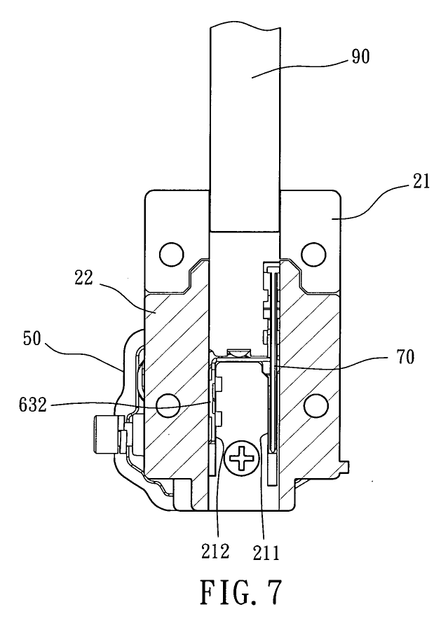

If a T-shaped nail strip 70 is loaded, the compression spring 62 imparts a forward pressure to the nail push plate 63 to force the first nail-pushing portion 631 against the rear end of the T-shaped nail strip 70 (see FIG. 6), causing the front end of the T-shaped nail strip 70 to be moved out of the first channel 11 into the T-nail outlet 211 of the nail output head 20 (see FIG. 7), and therefore the user can operate the nail driving mechanism 90 to drive the first T-shaped nail of the T-shaped nail strip 70 out of the nail output port into the workpiece (not shown).

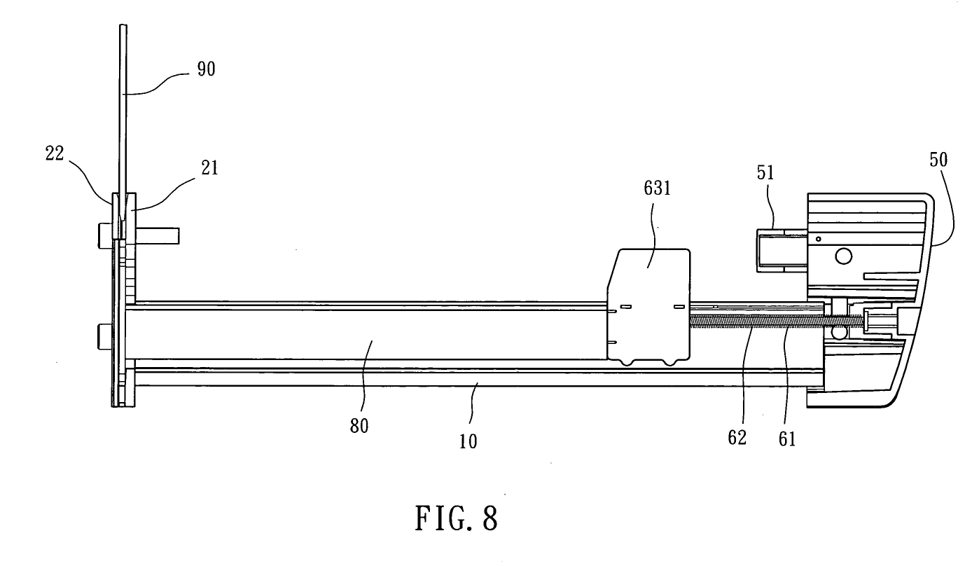

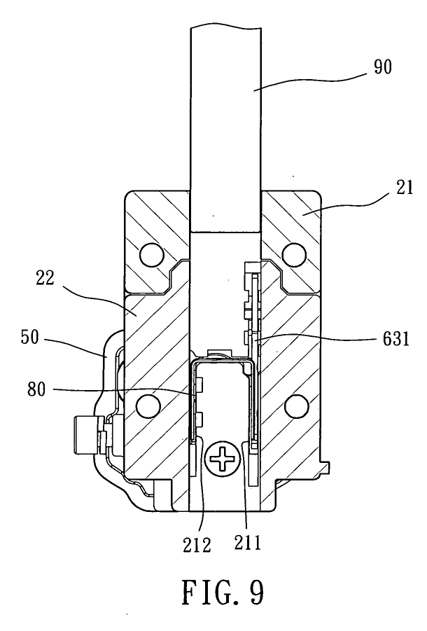

If an inverted U-shaped nail strip 80 is loaded, the compression spring 62 imparts a forward pressure to the nail push plate 63 to force the second nail-pushing portion 632 against the rear end of the inverted U-shaped nail strip 80 (see FIG. 8), causing the front end of the inverted U-shaped nail strip 80 to be moved out of the first channel 11 and third channel 13 of the channel bar 10 into the U-nail outlet 212 of the nail output head 20 (see FIG. 9), and therefore the user can operate the nail driving mechanism 90 to drive the first inverted U-shaped nail of the inverted U-shaped nail strip 80 out of the nail output port into the workpiece (not shown).

As indicated above, by means of moving the sliding bar 40 from the close position to the open position, the nail strip can be conveniently loaded in the nail magazine 100 of the present invention. In addition, since the nail push plate 63 is sleeved onto the rod member 61 and supported by the compression spring 62, the nail push plate 60 can positively urge the T-shaped nail or the inverted U-shaped nail when the nail push plate 60 is forced by the compression spring 62 to move forwards along the rod member 61, preventing bias or jam of the nail.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A dual-use nail magazine for alternatively accommodating a strip of T-shaped nails or a strip of inverted U-shaped nails, the nail magazine comprising:
a track bar having a first channel for receiving a T-shaped nail strip when it is used alone, a second channel, a third channel cooperated with the first channel for receiving an inverted U-shaped nail strip, and at least one guide rail;
a limiter fastened to the track bar and provided with a retaining hole;
a sliding bar having at least one sliding groove coupled to the at least one guide rail of the track bar to guide reciprocation of the sliding bar along the track bar, and a protruding portion at one end thereof;
a locating block affixed to the other end of the sliding bar remote from the protruding portion and provided with a retaining member; and
a nail pushing mechanism having a rod member received in the second channel of the track bar and having one end affixed to the locating block, a nail push plate moveably sleeved onto the rod member, and a compression spring sleeved onto the rod member and stopped between the locating block and the nail push plate to move the nail pusher along the first channel and the third channel so as to push the T-shaped nail strip in the first channel or the inverted U-shaped nail strip in the first and third channels in direction away from the locating block.

2. The dual-use nail magazine as claimed in claim 1, further comprising a nail output head having a nail guiding plate fastened to one end of the track bar and a guard fastened to the nail guiding plate, the nail guiding plate defining a T-nail outlet in communication with the first channel of the track bar and a U-nail outlet in communication with the first channel and third channel of the track bar, the guard defining with the nail guiding plate a nail output port.

3. The dual-use nail magazine as claimed in claim 1, wherein the sliding bar defines with the track bar a clearance of a predetermined configuration for receiving an inverted U-shaped nail strip and a T-shaped nail strip selectively.

4. The dual-use nail magazine as claimed in claim 1, wherein the nail push plate has a substantially h-shaped cross section defining a first nail-pushing portion inserted into the first channel of the track bar, and a second nail-pushing portion inserted into the third channel of the track bar.

5. The dual-use nail magazine as claimed in claim 1, wherein the rod member of the nail pushing mechanism has a stop block disposed at one end thereof for stopping the nail push plate movably sleeved onto the rod member.

6. The dual-use nail magazine as claimed in claim 1, wherein the sliding bar is a single-piece bar.

7. The dual-use nail magazine as claimed in claim 1, wherein the sliding bar has defined therein a plurality of nail grooves disposed at different elevations for guiding different lengths of T-shaped nail strips.

8. The dual-use nail magazine as claimed in claim 1, wherein the sliding bar is movable along the track bar by an external force between an open position and a close position; the protruding portion of the sliding bar is stopped at the limiter when the sliding bar is in the open position; the retaining member is engaged into the retaining hole of the limiter when the sliding bar is in the close position.
